(19) United States
(12) Patent Application Publication
(10) Pub. No.: US 2025/0212156 A1
(43) Pub. Date: Jun. 26, 2025

(54) METHOD AND APPARATUS FOR POSITIONING IN WIRELESS COMMUNICATION SYSTEM

(71) Applicant: Samsung Electronics Co., Ltd., Gyeonggi-do (KR)

(72) Inventors: Qi XIONG, Beijing (CN); Feifei SUN, Beijing (CN); Longhai ZHAO, Beijing (CN); Pengru LI, Beijing (CN)

(21) Appl. No.: 18/849,831

(22) PCT Filed: Apr. 20, 2023
(86) PCT No.: PCT/KR2023/005345

§ 371 Date: Sep. 23, 2024

(30) Foreign Application Priority Data
Apr. 20, 2022 (CN) 202210419033.4

(51) Int. Cl. H04W 64/00; H04W 24/08

(52) U.S. Cl. CPC H04W 64/00; H04W 24/08

(57) ABSTRACT

The disclosure relates to a 5G or 6G communication system for supporting a higher data transmission rate. The disclosure provides a method and apparatus for positioning and particularly provides a method executed by a first node in a communication system, including: acquiring configuration information related to a positioning-related first-type method; and performing a positioning-related operation based on the configuration information related to the positioning-related first-type method.

### TECHNICAL FIELD

The disclosure relates generally to wireless communication systems and, more specifically, the disclosure relates to a method and apparatus for positioning in a wireless communication system.

### BACKGROUND ART

In order to satisfy increased demands on the wireless data communication service since deployment of a 4G communication system, an improved 5G or quasi-5G communication system has been developed hard. Therefore, the 5G or quasi-5G communication system is also referred as a “super 4G network” or “post-LTE system”.

The 5G communication system is implemented in a higher frequency (mmWave) band, e.g., a 60 GHz band, so as to achieve a higher data rate. In order to reduce propagation loss of radio waves and increase the transmission distance, beamforming, massive Multiple Input Multiple Output (MIMO), Full-Dimensional Multiple Input Multiple Output (FD-MIMO), an array antenna, analog beamforming, and a large-scale antenna technology are discussed in the 5G communication system.

In addition, in the 5G communication system, development on the system network improvement is being carried out based on an advanced small cell, a cloud Radio Access Network (RAN), an ultra-dense network, Device-to-Device (D2D) communication, wireless backhaul, a mobile network, cooperative communication, Coordinated Multi-Point (COMP), receiving end interference elimination, and the like.

In the 5G system, hybrid Frequency Shift Keying (FSK) and Quadrature Amplitude Modulation (QAM) (FQAM) and Sliding Window Superposition Coding (SWSC) as Advanced Coded Modulation (ACM) and Filter Bank Multi-Carrier (FBMC), Non Orthogonal Multiple Access (NOMA), and Sparse Code Multiple Access (SCMA) as advanced access technologies have been developed.

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

The disclosure may provide a method and apparatus for positioning in a wireless communication system.

### Solution to Problem

According to an embodiment of the disclosure, provided is a method executed by a first node in a communication system, including: acquiring configuration information related to a positioning-related first-type method; and performing a positioning-related operation based on the configuration information related to the positioning-related first-type method.

According to an embodiment of the disclosure, the first node is user equipment or a network side device.

According to an embodiment of the disclosure, the positioning-related operation may be triggered based on one or more of the following items: a measured first signal is a multi-path signal; the measured first signal is a non-line-of-sight signal; a Reference Signal Received Power (RSRP) value of the measured first signal is greater than a threshold value; a transmission Timing Error (TE) or a transmission Timing Error Group (TEG) of the first signal is greater than a threshold value; a reception TE or a reception TEG of the first signal is greater than a threshold value; a transmission-reception TE or TEG of the first signal is greater than a threshold value; the transmission-reception TE/TEG of the first signal belongs to a specific range; an uncertain region in positioning assist information is greater than a threshold value; and an indication of using or activating the first-type method is received.

According to an embodiment of the disclosure, when the at least one triggering item occurs no smaller than N times and N is a positive integer which is not smaller than 1, the positioning-related operation can be triggered.

According to an embodiment of the disclosure, the indication of using or activating the first-type method may be received through one or more of a LTE Positioning Protocol (LPP) message and/or a Radio Resource Control (RRC) configuration message and/or a Media Access Control Control Element (MAC CE) and/or Downlink Control Information (DCI).

According to an embodiment of the disclosure, the first node may be the user equipment, and the indication of using or activating the first-type method may be a feedback message of a request message of using or activating the first-type method; and the request message of using or activating the first-type method may be transmitted through one or more of a Physical Uplink Control Channel (PUCCH) and/or the MAC CE and/or a Physical Random Access Channel (PRACH) and/or the LPP message.

According to an embodiment of the disclosure, the configuration information related to the positioning-related first-type method may include one or more of the followings: input information related to the first-type method and/or output information corresponding to the input information; a type of the first-type method; a hyper-parameter configuration information; a data set related parameter; a weight parameter; an offset parameter configuration; configuration information related to a positioning reference signal; a measurement gap of measurement; and a related configuration of a positioning reference signal processing window.

According to an embodiment of the disclosure, the weight parameter and/or the offset parameter configuration may include an initial value and/or an update value.

According to an embodiment of the disclosure, the positioning-related operation may include at least one of training, testing, operating, updating, recovering or terminating.

According to an embodiment of the disclosure, the training may include one or more of the following operations: determination of a third node; and carrying out training of the first-type method according to the determined third node.

According to an embodiment of the disclosure, a device that satisfies one or more of the following conditions may be determined as the third node: the device has known position information; the device reports a case of having the capability of providing the input information related to the first-type method and/or the output information; a state capable of providing the input information and/or the output information related to the first-type method is indicated as an activated state; the measured first signal is a single-path signal; the measured first signal is a line-of-sight signal; the RSRP value of the measured first signal is greater than a threshold value; the transmission TE or the transmission TEG of the first signal is smaller than a threshold value; the reception TE or the reception TEG of the first signal is smaller than a threshold value; the transmission-reception TE or TEG of the first signal is smaller than a threshold value; and the transmission-reception TE/TEG of the first signal belongs to a specific range.

According to an embodiment of the disclosure, the input information related to the first-type method may be fed back through the third node.

According to an embodiment of the disclosure, the testing may include one or more of the followings: acquiring testing data; carrying out testing of the first-type method based on the testing data, obtaining output information, and determining validity of the first-type method; and determining whether the testing is successfully completed based on the validity of the first-type method.

According to an embodiment of the disclosure, the validity of the first-type method may be determined based on the following condition that: a difference value between the output information and output information in the testing data is smaller than a first threshold value.

According to an embodiment of the disclosure, provided is user equipment in a communication system, including: a transceiver, which is configured to transmit and receive a signal; and a controller, which is coupled with the transceiver and configured to execute the operations in the related method above.

According to an embodiment of the disclosure, provided is a base station in a communication system, including: a transceiver, which is configured to transmit and receive a signal; and a controller, which is coupled with the transceiver and configured to execute the operations in the related method above.

In still a further aspect of the present application, provided is a non-transient computer readable medium, with a computer executable instruction stored therein. When being executed by a processor, the instruction enables the processor to execute the method as mentioned above.

### Advantageous Effects of Invention

The disclosure may provide a method and apparatus for positioning in a wireless communication system.

### BRIEF DESCRIPTION OF DRAWINGS

FIG. 1 shows an example wireless network 100 according to an embodiment of the disclosure.

FIG. 2a shows an example wireless transmission path according to an embodiment of the disclosure.

FIG. 2b shows an example wireless reception path according to an embodiment of the disclosure.

FIG. 3a shows example User Equipment (UE) 116 according to an embodiment of the disclosure.

FIG. 3b shows an example gNB 102 according to an embodiment of the disclosure.

FIG. 4 shows a flow chart of an example of a method for executing a positioning operation according to an embodiment of the disclosure.

FIG. 5 shows a flow chart of an example of a method for executing a positioning operation according to an embodiment of the disclosure.

FIG. 6 shows a block diagram of user equipment according to an embodiment of the disclosure.

FIG. 7 shows a block diagram of a base station according to an embodiment of the disclosure.

### MODE FOR THE INVENTION

The exemplary embodiments of the disclosure will be further described below in combination with the drawings.

Description of the following reference drawings is provided to facilitate comprehensively understanding various embodiments of the disclosure defined by claims and equivalents thereof. The description includes various specific details to facilitate understanding, but merely should be considered exemplary. Therefore, those ordinary skilled in the art will realize that various changes and modifications can be made to various embodiments described herein without departure from the scope and the spirit of the disclosure. In addition, for clarity and conciseness, description on common known functions and structures can be omitted.

The text and the drawings are merely provided as examples so as to help readers to understand the disclosure. They are not intended to and also should not be explained to limit the scope of the disclosure in any ways. Although certain embodiments and examples have been provided, based on the content disclosed by this article, it is apparent for those skilled in the art that the shown embodiments and examples can be changed without departure from the scope of the disclosure.

Terms and wordings used in the Description and Claims below are not limited to their dictionary meanings, but are merely used by an inventor for clearly and consistently understanding the disclosure. Therefore, it is obvious for those skilled in the art that the following description on various embodiments of the disclosure is provided just for graphical representation, but not intended to limit the disclosure as defined by the appended claims and equivalents thereof

It should be understood that words “a/an”, “one”, and “the” in a singular form include plural reference, unless otherwise indicated clearly in the context. Therefore, for example, the reference to “part surface” includes reference to one or more such surfaces.

Terms such as “include” or “may include” refer to existence of correspondingly disclosed functions, operations or components which can be used in various embodiments of the disclosure, rather than limit existence of one or more additional functions, operations or features. In addition, terms such as “include” or “have” can be interpreted to represent certain features, numbers, steps, operations, components, modules or a combination thereof, but not exclusive of the possibility of existence of one or more other features, numbers, steps, operations, components, modules or a combination thereof.

The term “or” used in various embodiments of the disclosure includes any listed terms and all combinations thereof. For example, “A or B” may include A, may include B, or may include both A and B.

Unless defined differently, all terms (including technical terms or scientific terms) used in the disclosure have the same meanings understood by those skilled in the art as those described in the disclosure. For example, common terms defined in dictionaries are interpreted to have meanings consistent with the context in the related technical art, and should not be interpreted in an idealized or excessively formalized mode, unless definitely defined in the disclosure.

Without departure from the scope of the disclosure, the term “transmit” in the disclosure can be exchanged with “transfer”, “report”, “notify”, and the like for use.

The technical solutions of the embodiments of the present application can be applied to various communication systems, e.g., a Global System for Mobile communications (GSM) system, a Code Division Multiple Access (CDMA) system, a Wideband Code Division Multiple Access (WCDMA) system, a General Packet Radio Service (GPRS), A Long Term Evolution (LTE) system, a LTE Frequency Division Duplex (FDD) system, LTE Time Division Duplex (TDD), a Universal Mobile Telecommunication System (UMTS), a Worldwide Interoperability for Microwave Access (WiMAX) communication system, a 5^{th} generation (5G) system or a New Radio (NR), and the like. In addition, the technical solutions of the embodiments of the present application can be applied to future-oriented communication technologies.

A time domain unit (also referred to as a time unit) in the present application may be: an Orthogonal Frequency Division Multiplexing (OFDM) symbol, an OFDM symbol set (consisting of multiple OFDM symbols), a time slot, a time slot set (consisting of multiple time slots), a sub-frame, a sub-frame set (consisting of multiple sub-frames), a system frame, and a system frame set (consisting of multiple system frames); or may be a absolute time unit, e.g., 1 ms, 1 s, and the like. The time unit may also be a combination of various particle sizes, e.g., a combination of N1 time slots and N2 OFDM symbols.

A frequency domain unit (also referred to as a frequency unit) in the present application may be: a sub-carrier, a sub-carrier set (consisting of multiple sub-carriers), a Resource Block (RB) which may also be referred to as a Physical Resource Block (PRB), a RB set (consisting of multiple RBs), a Bandwidth Part (BWP), a BWP set (consisting of multiple BWPs), a frequency band/carrier, and a frequency band set/carrier set; or may be an absolute frequency domain unit, e.g., 1 Hz, 1 kHz, and the like. The frequency domain unit may also be a combination of various particle sizes, e.g., a combination of M1 PRBs and M2 sub-carriers.

Those skilled in the technical art could understand that a “terminal” and a “terminal device” used herein not only include a device with a wireless signal receiver, i.e., a device which is only provided with a wireless signal receiver without the transmitting capability, but also include a device with receiving and transmitting hardware, i.e., a device which is provided with receiving and transmitting hardware capable of carrying out bidirectional communication on a bidirectional communication link. Such device may include: a cellular device or other communication devices, i.e., a cellular device or other communication devices with a single line display or a multi-line display or without the multi-line display; a Personal Communications Service (PCS) with the capability of speech combination, data processing, faxing, and/or data communication; a Personal Digital Assistant (PDA) which may include a radio frequency (RF) receiver, a pager, Internet/Intranet access, a network browser, a notebook, a calendar, and/or a Global Positioning System (GPS) receiver; and a conventional laptop and/or palmtop computer and other devices, i.e., a conventional laptop and/or palmtop computer and other devices with and/or including a RF receiver. The “terminal” and the “terminal device used herein may be portable, transportable and mounted in a vehicle (aviation, sea transportation, and/or land), or may be suitable and/or configured to run locally, and/or run in a distributed form at any other positions in the earth and/or space. The “terminal” and the “terminal device” used herein may also be a communication terminal, an Internet surfing terminal, and a music/video playing terminal, and for example, may be a PDA, a Mobile Internet Device (MID), and/or a mobile phone with the music/video playing function, or may be a device such as a smart television, a set top box, and the like.

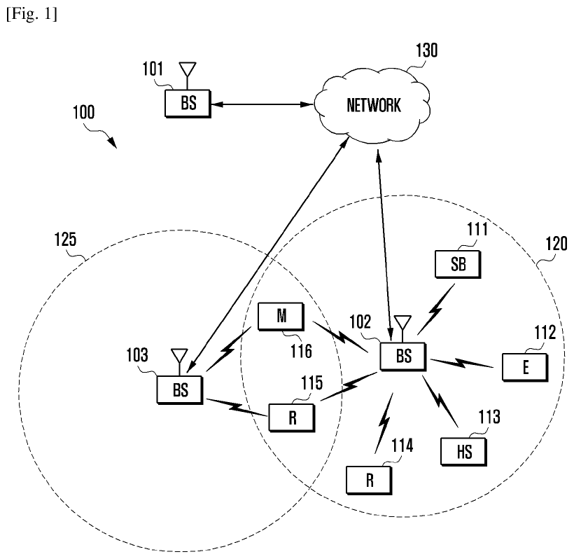

FIG. 1 shows an exemplary wireless network 100 according to various embodiments of the disclosure. An embodiment of the wireless network 100 shown in FIG. 1 is merely used for illustration. Other embodiments of the wireless network 100 can be used without departure from the scope of the disclosure.

The wireless network 100 includes a gNodeB (gNB) 101, a gNB 102, and a gNB 103. The gNB 101 is communicated with the gNB 102 and the gNB 103. The gNB 101 is also communicated with at least one Internet Protocol (IP) network 130 (such as the Internet, a private IP network or other data networks).

Up to the network type, other well-known terms such as “base station” or “access point” may be used instead of “gNodeB” or “gNB”. For convenience, the terms “gNodeB” and “gNB” in the present document are used for referring to a network infrastructure component which provides wireless access for a remote terminal. Moreover, up to the network type, other well-known terms, such as “mobile station”, “user station”, “remote terminal”, “wireless terminal” or “user apparatus”, may be used instead of “user device” or “UE”. For convenience, the terms such as “user equipment” and “UE” in the patent document are used for referring to a remote wireless device of a wireless access gNB, no matter whether the UE is a mobile device (e.g., a mobile phone or a smart phone) or a common fixed device (e.g., a desk computer or a vending machine).

The gNB 102 provides wireless broadband access to the network 130 for a plurality of pieces of first UE in a coverage region 120 of the gNB 120. The plurality pieces of first UE include: UE 111, which may be positioned in a small business (SB); UE 112, which may be positioned in an enterprise (E); UE 113, which may be positioned in a WiFi hotspot (HS); UE 114, which may be positioned in a first residence (R); UE 115, which may be positioned in a second residence (R); and UE 116, which may be a mobile device (M), such as a cellular phone, a wireless laptop computer, a wireless PDA, and the like. The gNB 103 provides wireless broadband access to the network 130 for a plurality of pieces of second UE in a coverage region 125 of the gNB 103. The plurality of pieces of second UE include UE 115 and UE 116. In some embodiments, one or more of the gNBs 101-103 may be communicated with each other and communicated with the UE 111-116 by using 5G, LTE, LTE-A, WiMAX or other advanced wireless communication technologies.

Approximate ranges of the coverage regions 120 and 125 are shown with dotted lines, and the ranges are shown roughly circular just for illustration and explanation. It should be clearly understood that a coverage region associated with the gNB, such as the coverage regions 120 and 125, may have other shapes including irregular shapes according to changes of the configuration of the gNB and a radio environment associated with a natural obstacle and an artificial obstacle.

As described in more detail below, one or more of the gNB 101, the gNB 102, and the gNB 103 include a 2D antenna array as described in an embodiment of the disclosure. In some embodiments, one or more of the gNB 101, the gNB 102, and the gNB 103 support a codebook design and structure for a system with the 2D antenna array.

Although FIG. 1 shows an example of a wireless network 100, various changes can be made to FIG. 1. For example, the wireless network 100 may include any number of gNBs and any number of UE which are properly arranged. Moreover, the gNB 101 may be directly communicated with any number of UE and provide wireless broadband access to the network 130 for the UE. Similarly, each of the gNBs 102-103 may be directly communicated with the network 130 and provide direct wireless broadband access to the network 130 for the UE. In addition, the gNBs 101, 102, and/or 103 may provide access to other or additional external networks (e.g., an external telephone network or other types of data networks).

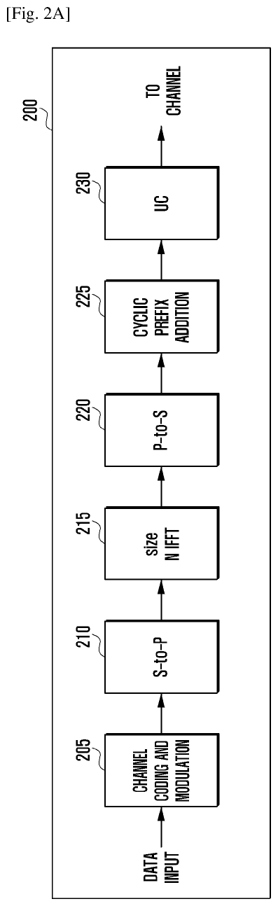

FIG. 2a and FIG. 2b show an exemplary wireless transmission path and an exemplary wireless reception path according to the disclosure. In the following description, a transmission path 200 can be described to be implemented in a gNB (e.g., the gNB 102), while a reception path 250 can be described to be implemented in UE (e.g., the UE 116). However, it should be understood that the reception path 250 can be implemented in the gNB, and the transmission path 200 can be implemented in the UE. In some embodiments, the reception path 250 is configured to support the codebook design and structure for the system with the 2D antenna array as described in the embodiments of the disclosure.

The transmission path 200 includes a channel coding and modulation block 205, a serial-to-parallel (S-to-P) block 210, an N-point Inverse Fast Fourier Transform (IFFT) block 215, a parallel-to-serial (P-to-S) block 220, a cyclic prefix adding block 225, and an up-converter (UC) 230. The reception path 250 includes a down-converter (DC) 255, a cyclic prefix removal block 260, a serial-to-parallel (S-to-P) block 265, an N-point Fast Fourier Transform (FFT) block 270, a parallel-to-serial (P-to-S) block 275, and a channel decoding and demodulation block 280.

In the transmission path 200, the channel coding and modulation block 205 receives a set of information bits, applies a code (e.g., a Low Density Parity Check (LDPC) code), and modulates an input bit (for example, by utilizing Quadrature Phase Shift Keying (QPSK) or Quadrature amplitude modulation (QAM)) so as to generate a sequence of a frequency domain modulation symbol. The serial-to-parallel (S-to-P) block 210 converts (e.g., demultiplexes) a serial modulation symbol into parallel data so as to generate N parallel symbol flows, where N represents the number of IFFT/FFT points used in the gNB 102 and the UE 116. The N-point IFFT block 215 performs an IFFT operation on the N parallel symbol flows so as to generate a time domain output signal. The parallel-to-serial block 220 converts (e.g., multiplexes) a parallel time domain output symbol from the N-point IFFT block 215 so as to generate a serial time domain signal. The cyclic prefix adding block 225 inserts a cyclic prefix into the time domain signal. The up-converter 230 modulates (e.g., up-converts) an output of the cyclic prefix adding block 225 into the RF frequency so as to carry out transmission via a wireless channel. Before frequency conversion to the RF frequency, the signal can also be filtered at a baseband.

An RF signal transmitted from the gNB 102 reaches the UE 116 after passing through the wireless channel, and an operation opposite to that at the gNB 102 is performed at the UE 116. The down-converter 255 down-converts the received signal into a baseband frequency, and the cyclic prefix removal block 260 removes the cyclic prefix so as to generate a serial time domain baseband signal. The serial-to-parallel block 265 converts the time domain baseband signal into a parallel time domain signal. The N-point FFT block 270 executes a FFT algorithm to generate N parallel frequency domain signals. The parallel-to-serial block 275 converts the frequency domain signal into a sequence of a modulated data symbol. The channel decoding and demodulation block 280 demodulates and decodes the modulated symbol so as to recover an original input data flow.

Each of the gNBs 101-103 can implement the transmission path 200 for carrying out transmission to the UE 111-116 in a downlink similarly, and can implement the reception path 250 for carrying out reception from the UE 111-116 in an uplink similarly. Similarly, each of the UE 111-116 can implement the transmission path 200 for carrying out transmission to the gNBs 101-103 in the uplink, and can implement the reception path 250 for carrying out reception from the gNBs 101-103 in the downlink.

Each of components in FIG. 2a and FIG. 2b can be implemented only by using hardware, or implemented by using a combination of hardware and software/firmware. As a specific example, at least some of the components in FIG. 2a and FIG. 2b can be implemented by software, while other components can be implemented by configurable hardware or a mixture of software and configurable hardware. For example, the FFT block 270 and the IFFT block 215 may be implemented as configurable software algorithms, wherein the value of the point number N may be modified according to an implementation mode.

In addition, although FFT and IFFT are used in the description, it is just illustrative and should not be interpreted as limitation to the scope of the disclosure. Other types of transforms can be used, such as Discrete Fourier Transform (DFT) and Inverse Discrete Fourier Transform (IDFT) functions. It should be understood that for the DFT and IDFT functions, the value of the variable N may be a random integer (e.g., 1, 2, 3, 4, and the like), and for FFT and IFFT functions, the value of the variable N may be a random integer as the power of 2 (e.g., 1, 2, 3, 8, 16, and the like).

Although FIG. 2a and FIG. 2b show examples of the wireless transmission path and the wireless reception path, various changes can be make to FIG. 2a and FIG. 2b. For example, various components in FIG. 2a and FIG. 2b can be combined, further subdivided or omitted, and additional components can be added according to specific demands. In addition, FIG. 2a and FIG. 2b are intended to show examples of types of the transmission and reception paths capable of being used in the wireless network. Any other proper architectures can be used for supporting wireless communication in the wireless network.

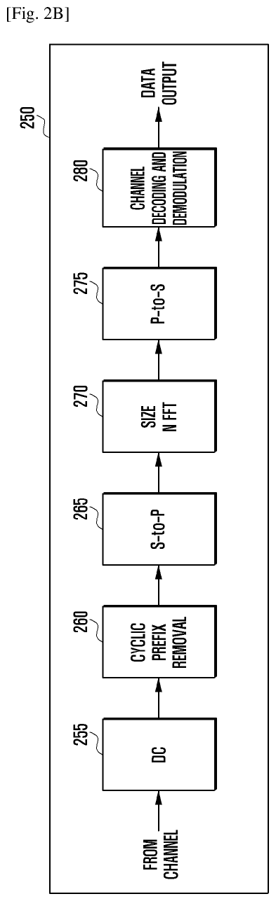

FIG. 3a shows example UE 116 according to the disclosure. The embodiment of the UE 116 shown in FIG. 3a is merely used for illustration, and the UE 111-115 in FIG. 1 may have the same or similar configuration. However, the UE has various configurations, and FIG. 3a is not intended to limit the scope of the disclosure to any specific implementation mode of the UE.

The UE 116 includes an antenna 305, a RF transceiver 310, a transmission (TX) processing circuit 315, a microphone 320, and a reception (RX) processing circuit 325. The UE 116 further includes a speaker 330, a processor/controller 340, an input/output (I/O) interface 345, (multiple) input devices 350, a display 355, and a memory 360. The memory 360 includes an operation system (OS) 361 and one or more applications 362.

The RF transceiver 310 receives an input RF signal transmitted by the gNB of the wireless network 100 via the antenna 305. The RF transceiver 310 down-converts the input RF signal to generate an intermediate frequency (IF) or baseband signal. The IF or baseband signal is transmitted to the RX processing circuit 325, wherein the RX processing circuit 325 generates a processed baseband signal by filtering, decoding, and/or digitalizing the baseband or IF signal. The RX processing circuit 325 transmits the processed baseband signal to the speaker 330 (for example, for speech data) or transmits the processed baseband signal to the processor/controller 340 (for example, for network browsing data) so as to carry out further processing.

The TX processing circuit 315 receives analog or digital speech data from the microphone 320, or receives other output baseband data (e.g., network data, e-mails, or interactive video game data) from the processor/controller 340. The TX processing circuit 315 codes, multiplexes, and/or digitalizes the output baseband data to generate a processed baseband or IF signal. The RF transceiver 310 receives the output processed baseband or IF signal from the TX processing circuit 315, and up-converts the baseband or IF signal into a RF signal transmitted via the antenna 305.

The processor/controller 340 may include one or more processors or other processing devices, and executes the OS 361 stored in the memory 360 so as to control the total operation of the UE 116. For example, the processor/controller 340 may control reception of a forward channel signal and transmission of a backward channel signal according to the common general principle through the RF transceiver 310, the RX processing circuit 325, and the TX processing circuit 315. In some embodiments, the processor/controller 340 includes at least one microprocessor or microcontroller.

The processor/controller 340 may also execute other processes and programs which are resident in the memory 360, e.g., operations of channel quality measurement and reporting for the system with the 2D antenna array as described in the embodiments of the disclosure. The processor/controller 340 may shift data in or out of the memory 360 according to demands of the executing process. In some embodiments, the processor/controller 340 is configured to execute the application 362 based on the OS 361 or in response to a signal received from the gNB or the operator. The processor/controller 340 is also coupled to the I/O interface 345, wherein the I/O interface 345 provides the capability of connecting to other devices such as the laptop computer and the hand-held computer for the UE 116. The I/O interface 345 is a communication path between these attachments and the processor/controller 340.

The processor/controller 340 is also coupled to the (multiple) input devices 350 and the display 355. An operator of the UE 116 may input data into the UE 116 by using the (multiple) input devices 350. The display 355 may be a liquid crystal display or other displays capable of rendering a text and/or at least (e.g., from a website) a finite graph. The memory 360 is coupled to the processor/controller 340. One portion of the memory 360 may include a Random Access Memory (RAM), and the other portion of the memory 360 may include a flash or other Read Only Memories (ROMs).

Although FIG. 3a shows one example of the UE 116, various changes can be made to FIG. 3a. For example, various components in FIG. 3a can be combined, further subdivided or omitted, and additional components can be added according to specific demands. As a specific example, the processor/controller 340 can be divided into a plurality of processors, such as one or more Center Processing Units (CPUs) and one or more Graphic Processing Units (GPUs). Moreover, although FIG. 3a shows the UE 116 configured as the mobile phone or the smart phone, the UE can be configured to perform operations as other types of mobile or fixed devices.

FIG. 3b shows an example gNB 102 according to the disclosure. The embodiment of the gNB 102 shown in FIG. 3b is merely used for illustration, and other gNBs in FIG. 1 may have the same or similar configuration. However, the gNB has various configurations, and FIG. 3b is not intended to limit the scope of the disclosure to any specific implementation mode of the gNB. It should be noted that the gNB 101 and the gNB 103 may include the same or similar structure with the gNB 102.

As shown in FIG. 3b, the gNB 102 includes a plurality of antennas 370a-370n, a plurality of RF transceivers 372a-372n, a TX processing circuit 374, and a RX processing circuit 376. In some embodiments, one or more of the plurality of antennas 370a-370n include the 2D antenna array. The gNB 102 further includes a controller/processor 378, a memory 380, and a backhaul or network interface 382.

The RF transceivers 372a-372n receive input RF signals from the antennas 370a-370n, such as signals transmitted by the UE or other gNBs. The RF transceivers 372a-372n down-convert the input RF signals to generate IF or baseband signals. The IF or baseband signals are transmitted to the RX processing circuit 376, wherein the RX processing circuit 376 generates processed baseband signals by filtering, decoding, and/or digitalizing the baseband or IF signals. The RF processing circuit 376 transmits the processed baseband signals to the controller/processor 378 so as to carry out further processing.

The TX processing circuit 374 receives analog or digital data (e.g., speech data, network data, e-mails, or interactive video game data) from the controller/processor 378. The TX processing circuit 374 codes, multiplexes, and/or digitalizes the output baseband data to generate a processed baseband or IF signal. The RF transceivers 372a-372n receive the output processed baseband or IF signal from the TX processing circuit 374, and up-convert the baseband or IF signal into a RF signal transmitted via the antennas 370a-370n.

The controller/processor 378 may include one or more processors or other processing devices for controlling the total operation of the gNB 102. For example, the controller/processor 378 may control reception of the forward channel signal and transmission of the backward channel signal according to the common general principle through the RF transceivers 372a-372n, the RX processing circuit 376, and the TX processing circuit 374. The controller/processor 378 can also support additional functions, such as a more advanced wireless communication function. For example, the controller/processor 378 can execute a process such as a Blind Interference Sensing (BIS) process executed by a BIS algorithm, and decode the received signal from which an interference signal is removed. The controller/processor 378 can support any one of various other functions in the gNB 102. In some embodiments, the controller/processor 378 includes at least one microprocessor or microcontroller.

The controller/processor 378 may also execute a program and other processes which are resident in the memory 380, e.g., a basic OS. The controller/processor 378 may also support channel quality measurement and reporting for the system with the 2D antenna array as described in the embodiments of the disclosure. In some embodiments, the controller/processor 378 supports communication between entities such as web RTCs. The controller/processor 378 may shift data in or out of the memory 380 according to demands of the executing process.

The controller/processor 378 is also coupled to the backhaul or network interface 382. The backhaul or network interface 382 allows the gNB 102 to be communicated with other devices or systems through a backhaul connection or through a network. The backhaul or network interface 382 may support communication through any proper (multiple) wired or wireless connections. For example, when the gNB 102 is implemented as one portion of a cellular communication system (e.g., a cellular communication system supporting 5G or a new radio access technology or NR, LTE or LTE-A), the backhaul or network interface 382 can allow the gNB 102 to be communicated with other gNBs through the wired or wireless backhaul connection. When the gNB 102 is implemented as an access point, the backhaul or network interface 382 can allow the gNB 102 to be communicated with a larger network (e.g., the Internet) through a wired or wireless local area network or through the wired or wireless connection. The backhaul or network interface 382 includes any proper structure supporting communication through the wired or wireless connection, such as the Ethernet or the RF transceiver.

The memory 380 is coupled to the controller/processor 378. One portion of the memory 380 may include a RAM, and the other portion of the memory 380 may include a flash or other ROMs. In some embodiments, a plurality of instructions, such as the BIS algorithm, are stored in the memory. The plurality of instructions are configured to enable the controller/processor 378 to execute the BIS process and decode the received signal after removing at least one interference signal determined by the BIS algorithm.

As described in more detail below, (implemented by using the RF transceivers 372a-372n, the TX processing circuit 374, and/or the RX processing circuit 376) the transmission and reception paths of the gNB 102 support communication with an aggregation of a FDD cell and a TDD cell.

Although FIG. 3b shows one example of the gNB 102, various changes can be made to FIG. 3b. For example, the gNB 102 may include any number of components shown in FIG. 3a. As a specific example, an access point may include many backhaul or network interfaces 382, and the controller/processor 378 may support a routing function so as to route data among different network addresses. As another specific example, although it is shown to include one single instance of the TX processing circuit 374 and one single instance of the RX processing circuit 376, the gNB 102 may include multiple instances of each of the TX processing circuit 374 and the RX processing circuit 376 (e.g., each RF transceiver corresponds to one)

A transmission link of a wireless communication system mainly includes: a communication downlink from a 5G gNB to UE and a communication uplink from the UE to the network.

Nodes for positioning measurement in the wireless communication system, e.g., a current wireless communication system, include: UE for initiating a positioning request message, a Location Management Function (LMF) for positioning the UE and issuing positioning assist data, a gNB or Transmission-Reception Point (TRP) for broadcasting the positioning assist data and carrying out uplink positioning measurement, and UE for downlink positioning measurement. In addition, a method disclosed by the disclosure may also be expanded to be applied in other communication systems, e.g., vehicle communication (V2X), i.e., sidelink communication, and at the moment, the TRP or the UE may be any one device in the V2X.

In recent years, an Artificial Intelligence (AI) technology represented by a deep learning algorithm is risen again, solves the difficult problems that have existed for many years in different walks of life, and achieves great success technologically and commercially. Along with continuous evolution of the wireless communication system, these problems that exist in an air interface are also researched all the time and new methods are introduced for a trial for solving the problems. In order to solve some problems encountered in the communication process, a machine learning (ML) method can be started, wherein the ML method generally includes a ML algorithm design and a ML model design on which the algorithm is based. A solution based on an AI Deep Learning (DL) technology generally refers to an algorithm taking an artificial neural network as a model in the ML technology. A DL network model is generally composed of multiple layers of stacked artificial neural networks, adjusts weight parameters in the neural networks by training existing data, and then is used for achieving the task objective in a non-encounter case in a reasoning phase. Meanwhile, generally speaking, compared to a general solution or algorithm based on a fixed rule, the DL-based solution needs to have higher operational capability than an original classical algorithm, which generally needs a specialized operation chip in a device that runs the DL algorithm to support more effective running of the DL algorithm.

The problems encountered in communication and solved by using the ML-based AI algorithm generally needs to satisfy the conditions that the problems of ML have. In the communication and the problems related to the air interface, acquiring device positioning is one type of typical problem that satisfies the conditions above to a certain degree, and thus can be solved by using the ML algorithm, and a better effect than that of the conventional solution is achieved in the communication transmission process and for example, in a non-line-of-sight environment.

For the currently used wireless communication system, a conventional positioning algorithm may provide normal services in some scenes, but for the ML algorithm, due to the completely different architecture and features thereof from those of the conventional algorithm, a using method thereof is completely different from that of the conventional algorithm. For the existing wireless communication system (4G, 5G, and possible future 6G wireless communication systems), there is a strict and uniform standard for limiting a configuration method and the behavioral process of the air interface in the communication process, and thus, in consideration of use of a new technology of ML in a new generation wireless communication system, the air interface must be designed in combination with features of a new communication system and the ML algorithm., wherein with respect to implementation of the ML-based algorithm in the air interface of the wireless communication system, a specific implementation process thereof, how to transmit and interact a signal between UE and a base station, a process of activating and closing the ML algorithm and model, updating of the ML algorithm and model in the using process, and the like need to be regulated and are all the emphases that need to be considered.

Therefore, based on the problems above, in order to use the ML-based solutions in the wireless communication system, it is necessary to propose an effective technical method so as to regulate specific measures of implementing these solutions in the system, processes that need to exist, and the like, and establish a proper framework for the ML-based method to solve the problems related to the air interface in the wireless communication.

In this article, use of a first-type method includes use of “the ML-based algorithm and model”, “a AI/ML-based technology”, “AI/ML for an NR air interface”, “an AI/ML technology”, “an AL/ML architecture”, “an AI/ML model”, “AI/ML for the air interface”, “an AI/ML method”, “an AI/ML related algorithm”, “an AI/ML-based algorithm”, and “an AI/ML solution”.

The disclosure provides application and configuration of a ML-based algorithm and model in a wireless communication system so as to complete or implement a positioning operation of the wireless communication system and acquisition of positioning information. The disclosure aims to solve the problem how to use the ML-based solutions in the wireless communication system to solve the problems that need to be solved in the air interface of wireless communication, propose how to use architectures, flows, methods, and the like of the ML solutions in the wireless communication system, implement application of the ML algorithm in the wireless communication system by designing the architectures, flows, methods, and the like, and achieve an effect of successfully using and implementing the ML method with a better effect than a conventional existing method in the communication system so as to further improve positioning performance of the wireless communication system.

In one embodiment of the disclosure, performing the positioning-related operation and/or acquisition of the positioning information by using the first-type method disclosed by the disclosure will be illustrated. Use of the first-type method disclosed by the disclosure includes use of the ML/AL technology and can implement the positioning-related operation and/or acquisition of the positioning information in a relatively “harsh” case, while the positioning-related operation and/or acquisition of the positioning information cannot be performed in such “harsh” case by a conventional method. Therefore, when the conditions are unsuitable for the conventional method, the first-type method disclosed by the disclosure will be triggered. Certainly, the first-type method disclosed by the disclosure can also be used in any cases without considering a triggering condition.

The disclosure illustrates a device (represented by a first node (a device A) in the disclosure) which uses a first-type method including one or more of the following parts (stages or modes or operations) in the using process:
Triggering part: the triggering part is optional. In the triggering part, it will be determined whether to trigger the first-type method and trigger the flow of the first-type method; and optionally, this part includes one or more of the following operations:
   Determining whether a certain triggering condition is satisfied, wherein in a case that a certain triggering condition is satisfied, it is determined to use the first-type method; if a certain triggering condition is not satisfied, the first-type method is not used; this mode has the advantage of facilitating higher pertinence of use of the first-type method, and the first-type method can be used when the conventional method may not give out a good result; and optionally, the certain triggering condition includes one or more of the following items:
      A measured first signal is a multi-path signal, and specifically, the measured first signal has more than one paths, wherein different paths have different arrival time and/or received power values;
      The measured first signal is a non-line-of-sight signal, and specifically, when a line-of-sight/non-line-of-sight (LoS/NLoS) indicator is false, the measured first signal is the non-line-of-sight signal (for example, when the indicator is a hard indicator, the indicator is NLoS); and/or when the value of the line-of-sight/non-line-of-sight indicator (for example, when the indicator is a soft indicator) is smaller than (not greater than) a possibility threshold value, the measured first signal is the non-line-of-sight signal with a high probability, wherein the threshold value is obtained by receiving an instruction and/or obtained by presetting;
      A Reference Signal Received Power (RSRP) value of the measured first signal is greater than (not smaller than) a threshold value, wherein the threshold value is obtained by receiving an instruction and/or obtained by presetting;
      A transmission Timing Error (Tx TE) or a transmission Timing Error Group (TEG) of the first signal is greater than (not smaller than) a threshold value, wherein the threshold value is obtained by receiving an instruction and/or obtained by presetting; and/or
      A reception TE (Rx TE) or a reception TEG of the first signal is greater than (not smaller than) a threshold value, wherein the threshold value is obtained by receiving an instruction and/or obtained by presetting;
      A transmission-reception TE or TEG of the first signal is greater than (not smaller than) a threshold value, wherein the threshold value is obtained by receiving an instruction and/or obtained by presetting;
      The transmission-reception TE or TEG of the first signal belongs to a specific range, wherein the specific range is obtained by receiving an instruction and/or obtained by presetting;
      An uncertain region in positioning assist information is greater than (not smaller than) a threshold value, wherein the threshold value is obtained by receiving an instruction and/or obtained by presetting;
      Optionally, when an indication of using the first-type method is received; for example, the indication of using the first-type method may be transmitted to UE by a network device, such as a base station device or a LMF;
      Optionally, when the at least one triggering condition occurs no smaller than (greater than) N times, N is a positive integer which is not smaller than 1, the N is obtained by receiving an instruction and/or obtained by presetting, and for example, a triggering condition counter reaches N+1 times;
      When the first-type method is an effective first-type method, i.e., a first-type method passing testing, this testing includes all or part of operations in the following testing portion;
      The first signal includes a reference signal for positioning (e.g., a downlink Positioning Reference Signal (PRS) and an uplink Sensing Reference Signal (SRS) for positioning in a cellular wireless communication system, and the like), and/or other reference signals in a wireless system, e.g., a Synchronization Signal Block (SSB) and/or a Channel State Information-Reference Signal (CSI-RS), and the like; and
   Executing the triggering flow; and optionally, executing the triggering flow includes one or more of the following operations:
      When a network side device (e.g., the LMF and/or the base station device) triggers use of the first-type method according to the triggering condition; use of the first-type method is indicated and/or activated through a LPP (LTE Positioning Protocol) message and/or a RRC configuration message and/or a MAC CE and/or DCI;
      When UE triggers use of the first-type method according to the triggering condition above, the UE receives an indication of using or activating the first-type method through a LPP message and/or a RRC configuration message and/or a MAC CE and/or DCI, or the UE requests for use of the first-type method to the network side device through a PUCCH and/or a MAC CE and/or a PRACH and/or a LPP message; the UE receives a feedback from the network side device for the request to determine whether to use the first-type method; and the feedback includes a method of indicating and/or activating use of the first-type method by the network side device;
      When the UE triggers the use of the first-type method according to the triggering condition above, the UE directly starts to use the first-type method; and such mode is relatively suitable for a case that the first-type method is deployed on the UE side;
Training part; the training part is optional. In this part, the first-type method used needs to be trained by training data, to obtain the first-type method after training; so, the device that may provide training data is represented as device B in the disclosure; optionally, the part includes one or more of the following operations:
   Transmission and/or reception of configuration information related to the first-type method; transmission and/or reception of such configuration information may help the device using the first-type method and/or training the first-type method to better use and train; wherein, The configuration information related to the first-type method includes one or more of the followings:
      Type of the first-type method, including: a type determined according to an AI method; and/or a type determined according to the number of Floating Point Operations (FLOP) of the neural network model; and/or a type determined according to latency requirements; and/or a type determined according to a required/supported data size (a size of a data set and/or a size of a data dimension); and/or a type determined depending on an operation used (e.g. convolution and/or matrix operation);
      Hyper-parameter configuration information, including learning rate and/or number of layers and/or batchsize and/or epoch times and/or clipvalue of data sets, etc.;
      Data set related parameters, including: a data type of a group of data; and/or the number of corresponding data type parameters (e.g., a group of data used for positioning includes N channel impulse response values, where, the channel impulse response values are data types, and N is the number of data type parameters), wherein, N is obtained by receiving instructions and/or is preset; and/or the number of groups of data;
Optionally, the size of the data set may be specific to the training part, and/or the testing part, and/or the testing part and the training part are common;
Optionally, the number of data type parameters in the data set is determined according to certain conditions; the conditions may help filter out more suitable and effective input information and/or reduce signaling overhead; and the certain conditions described include:
   Channel impulse response value being greater than (not less than) a threshold value; wherein, the threshold value is obtained by receiving instructions and/or is preset; for example, there are 4096 channel impulse response values in total; if only N channel impulse response values are greater than the threshold value, only the N channel impulse response values will be delivered (transmitted and/or received); N does not exceed the maximum value Nmax, where, N and Nmax are obtained by receiving instructions and/or are preset; and/or
   The first N channel impulse response values at arrival time and/or the first N channel impulse response values with highest power in all impulse responses, where, N is obtained by receiving instructions and/or preset;
The channel impulse response value includes a power value and/or arrival time of an arrival path;
   Weight parameters and/or offset parameter configuration, including initial values (e.g., settings of initial weight parameters and/or initial offset parameter obtained according to certain criteria, and/or initial weight parameters and/or initial offset parameter settings obtained according to received signaling) and/or updated values (e.g., updated weight parameters and/or offset parameter updated values obtained according to training and/or update and/or recovering), specifically, including:
Settings of initial weight parameters and/or initial offset parameters, including initial weight parameters and/or offset parameters obtained according to the determined probability distribution; and/or
Settings according to the received weight parameter configuration and/or offset parameter configuration, for example, weight parameters and/or offset parameter obtained through training or pre-training; such setting may be more suitable for online training or online training based on the first-type method obtained from pre-training;
Weight parameters and/or offset parameters being obtained and/or updated according to the training optimizer model and/or optimization effort and/or learning rate; for example, the updated value is obtained;
   Optionally, the configuration information related to the first-type method may be provided and sent by device B, and/or provided and sent by other device (e.g., device A using the first-type method), and received by device B;
   Determination of the third node (device B), wherein, the device meeting one or more of the following conditions may be determined as the third node or may be determined as a candidate third node:
      The device has known (or determined) position information;
      The device reports a case of having the capability of providing the input information related to the first-type method and/or the output information;
      A state capable of providing the input information and/or the output information related to the first-type method is indicated as an activated state (e.g., on, available, etc.);
      The measured first signal is a single-path signal; specifically, there is only one path including the measured first signal; wherein, there is only one path whose arrival time and/or received power value meet the set threshold value; wherein, the threshold value is obtained by receiving instructions and/or is preset;
      The measured first signal is a line-of-sight signal, specifically including: when the LoS/NLOS indicator indicator is true, that is, the first signal measured is the line-of-sight signal (e.g., when the indicator is a hard indicator, the indicator is LoS); when the LoS/NLOS indicated value (e.g., when the indicator is a soft indicator) is greater than (not less than) a probability threshold value, that is, when the measured first signal is a line-of-sight signal with in the high probability; wherein, the threshold value is obtained by receiving instructions and/or is preset;
         A Reference Signal Received Power (RSRP) value of the measured first signal is greater than (not less than) a threshold value; wherein, the threshold value is obtained by receiving instructions and/or is preset;
      A transmission Time Error (Tx TE) or a transmission Time Error Group (TEG) of the first signal is less than or (not greater than) a threshold value; wherein, the threshold value is obtained by receiving instructions and/or is preset;
      A reception Timing Error (Rx TE) or a reception TEG of the first signal is less than or (not greater than) a threshold value; wherein, the threshold value is obtained by receiving instructions and/or is preset;
      A transmission-reception TE or TEG transmission-reception TE or TEG of the first signal is less than or (not greater than) a threshold value; wherein, the threshold value is obtained by receiving instructions and/or is preset;
      The transmission-reception TE or TEG of the first signal belongs to a specific range; wherein, the specific range is obtained by receiving instructions and/or is preset;
   Transmission and/or reception of resource configuration information for training; wherein, the resource configuration information for training includes one or more of the followings:
      Configuration information related to the first-type method in the above-described training part;
      Configuration information related to a positioning reference signal for training (including index of positioning reference signal configuration, time-frequency resource position, cycle, etc. of the positioning reference signal);
      Configuration related to measurement gap (MG) and/or PRS Processing Window (PPW) for training measurement, including time length, cycle size, time start position, etc. of MG and/or PPW; configuring the measurement gap for training may better control the time needed to obtain training data, because the training data may only be obtained within a certain time range and may be effective for a period of time; for example, if a certain time is exceeded, the third node will also move to other places, and the training data given previously is no longer suitable; only effective training data may help to obtain suitable and effective first-type method;
   Training the first-type method according to the determined third node and the resources used for training; including one or more of the following operations:
      The third node obtains the input information related to the first-type method based on the obtained resource configuration information for training;
      Optionally, the third node feeds back the obtained input information related to the first-type method;
      Optionally, the third node feeds back the obtained input information related to the first-type method and the output information corresponding to the input information, for example, the third node UE feeds back the channel impulse response information obtained according to the received positioning reference signal and the position information of the third node at this time (including the global position information and/or local position information) to the network side device; and the method is more suitable for the case where the first-type method is deployed on the network side;
      Training the first-type method according to the obtained input information related to the first-type method provided by the third node and/or the output information corresponding to the input information;
   Determining the first-type method after completing training and/or configuration information related to the first-type method after completing training; including one or more of the followings:
      During the training process, adjusting the configuration information related to the first-type method; obtaining the configuration information related to the first-type method after training, and obtaining the new first-type method; optionally, such method is more suitable for the case where the training part is carried out by the device using the first-type method;
      Adjusting the configuration information related to the first-type method according to the obtained configuration information related to the first-type method after training, to obtain a new first-type method; optionally, such method is more suitable for the case where the training part is not (not directly) carried out by the device using the first-type method, and the updated configuration information of the first-type method after training is obtained from other device, to obtain a new first-type method;
Testing part; the testing part is optional. In this part, validity of the first-type method used will be tested; if the first-type method used is confirmed to be effective, the effective first-type method may be obtained; if the first-type method used is confirmed to be ineffective, the ineffective first-type method may be obtained, and then return to the triggering part, to determine the first-type method to be used again; in this part, event based trigger test and/or counting time based trigger test may be used; and specific illustration in the following updating part may be referred to for details of event based trigger and/or counting time based trigger. An advantage of testing is that whether the first-type method obtained by training is really effective and useful in the current situation may be judged; optionally, the part includes one or more of the following operations:
   Obtaining test data; the test data is used to test validity of the first-type method used, including the input information of the first-type method used and/or the output information corresponding to the input information; optionally, the input information of the first-type method used and the output information corresponding to the input information may be from device B and/or device C that specially provides test data;
   Determining validity of the first-type method tested; wherein, if the first-type method can successfully pass the test, for example, the test output information obtained by using the first-type method and the input information in the test data meets certain conditions, then the first-type method tested is determined to be effective, and the certain conditions include:
      A difference value between the output information and output information in the test data is less than (or not greater than) a first threshold value, wherein, the first threshold value is obtained by receiving instructions and/or is preset; such method is applicable to comparison of positioning accuracy, for example, the test output information is the positioning position information of device C obtained by applying the first-type method and the test input information, while the output information in the test data is the real positioning position information of device C. By comparing the difference value between the two, a positioning error is obtained; the smaller the positioning error is, the more accurate the positioning result obtained by using the first-type method is; when the positioning error obtained is less than (or not greater than) the set first threshold value, it may be determined that the tested first-type method successfully passed the test, otherwise, it may be determined that the tested first-type method failed to pass the test;
      The test output information is superior to (or not inferior to) the output information in the test data
   Completing the test process; when it is determined that the tested first-type method is effective, and/or the tested first-type method meets certain conditions, the test process may be considered as successful completion; when it is determined that the tested first-type method is ineffective, and/or the tested first-type method does not meet certain conditions, the test process may be considered as unsuccessful completion;
   Optionally, the first-type method used may be the first-type method after completing training and/or the first-type method obtained according to the configuration information related to the first-type method after completing training;
Operating (or inference) part; in this part, according to the obtained input information, the output information is obtained by using the obtained (or determined) first-type method and/or the configuration information related to the first-type method; optionally, the part includes one or more of the following operations:
   Determining the parameter configuration related to the first-type method used, including
      The parameter configuration information related to the first-type method includes the parameter configuration information identical to the parameter configuration information related to the first-type method introduced in the training part; optionally, the parameter configuration information is obtained by device A by receiving the configuration signaling sent by other device; for example, if device A is UE, the parameter configuration information required by the first-type method currently used is determined by receiving the parameter configuration information of the first-type method trained by the network side device; and/or
      Applying the determined parameter configuration information to configure the first-type method; optionally, a lower layer (e.g., a physical layer) receives parameter configuration instructions from an upper layer and configures the first-type method;
   Obtaining the input information related to the first-type method used; includes
      Obtaining the input information related to the first-type method by receiving and/or measuring the first signal;
      Obtaining the input information related to the first-type method by receiving feedback from other device;
      The input information includes the data set related parameters in the configuration information related to the first-type method in the above-described training part;
   Output information obtained according to the input information and by using the first-type method;
   Optionally, the first-type method obtained (or determined) further includes the first-type method obtained through testing and/or the effective first-type method;
Updating part; the updating part is optional. When using the first-type method, the first-type method used and/or the configuration information related to the first-type method used may change, for example, due to changes in the environment (e.g., changes in channel conditions), it is necessary to adjust the first-type method used and/or the configuration information related to the first-type method used; the advantage of such update is that the first-type method may be modified with less effort and/or in a shorter time, so that it may operate again; optionally, the part includes one or more of the following operations:
   Trigger updates, including event based trigger updates and/or count timing trigger updates, specifically including one or more of the followings:
      Event based trigger updates; that is, when a certain event occurs, update of the first-type method is started; specifically, the certain event includes one or more of the followings:
When the output information of the first-type method does not meet the required threshold value, wherein, the threshold value is obtained by receiving instructions and/or is preset; for example, the first-type method is used for obtaining position information, and a difference value between the output positioning position obtained by using the first-type method and the real positioning position (or an expected positioning position, or a positioning position obtained by using other method, etc.) is greater than a certain threshold; optionally, the threshold may be an uncertainty range of the position information;
When the number and/or type of the obtained input information does not meet the required threshold value, wherein, the threshold value is obtained by receiving instructions and/or is preset; for example, when the first-type method is used for obtaining the position information, device A does not obtain enough channel impulse response information, and cannot use the first-type method for obtaining the position information; for example
   Obtaining input information provided by less than or no more than N devices, where, N is obtained by receiving instructions and/or is preset;
   Obtaining measurement results of less than or no more than N positioning reference signal resources, where, N is obtained by receiving instructions and/or is preset;
   Obtaining less than or no more than N pieces of CIR/RSRP/angle correlation/phase correlation information, where, N is obtained by receiving instructions and/or is preset;
      Trigger updates based on counting and/or timing; including one or more of the following conditions and operation combinations:
Determining that the operation counter of the first-type method is initially set to 1 and/or the operation timing of the first-type method starts, when using the first-type method or receiving the indication to use the first-type method;
Running the counter to plus 1 and/or the counter of the first-type method to stop timing (or it is determined to be expired), when the event in the above-described event based trigger occurs;
Running the counter to plus 1 and/or the counter of the first-type method to stop timing (or it is determined to be expired), when an operation cycle is completed; the operation cycle includes applying the first-type method to obtain the input information, according to the obtained input information of the first-type method; optionally, the output information is output information that meets requirements (e.g., the difference value between the output positioning position and the real positioning position (or the expected positioning position, or the positioning position obtained by other method, etc.) is less than or not greater than a certain threshold);
Optionally, running the counter to plus 1 and/or the counter of the first-type method to stop timing (or it is determined to be expired), when the output information meeting the requirements is obtained;
When the counter value counter_value reaches or exceeds the set maximum value max (e.g., counter_value=max+1), the termination part and/or the updating part and/or the recovering part may be performed;
   Updating the first-type method used and/or the configuration information related to the first-type method used, including transmission and/or acquisition of the configuration information to be updated; specifically, including one or more of the followings or a combination thereof:
      Training, including some or all of the operations in the above-described training part, to obtain updated configuration information related to the first-type method;
      Requesting other device to update the configuration information related to the first-type method;
      Receiving updates of configuration information related to the first-type method sent from other device;
   Optionally, test is performed; the test includes some or all of the operations in the above-described test part;
Recovering part; the recovering part is optional. When the first-type method used does not meet the performance requirements or cannot operate normally, it may be necessary to recover the first-type method used and/or the configuration information related to the first-type method used; the recovering may modify the first-type method with greater effort and/or for a longer time, so that it may operate again; optionally, the part includes one or more of the following operations:
   Trigger the recovering process; when certain trigger conditions are met, the recovering process is triggered; the certain trigger conditions include:
      The certain events in update trigger of the above-described event based trigger; optionally, the certain event occurs up to or not less than N times, where, the N is obtained by receiving instructions and/or is preset;
      Conditions and/or operations in the above-described update trigger based on counting and/or timing;
      Event based trigger recovering and/or count timing based trigger recovering may be implemented. Specific description in the above-described updating part may be referred to for details of event based trigger and/or count timing based trigger.
   Recovering, including searching for new (or candidate) third nodes and/or training resources and/or training data for training and/or updating;
   Determining recovering results, including obtaining the first-type method or the configuration information related to the first-type method after recovering; optionally, the first-type method or the configuration information related to the first-type method after recovering further includes testing the first-type method after recovering and the first-type method obtained according to the configuration information related to the first-type method, and obtaining the first-type method and/or the configuration information related to the first-type method after recovering based on the test results;
Terminating part; the terminating part is optional. When the used first-type method has been used for a certain period of time and/or does not meet the requirements and/or cannot operate normally, the used first-type method and/or the configuration information related to the used first-type method may be terminated; optionally, the part includes one or more of the following operations:
   Terminating according to the termination trigger conditions; the termination trigger conditions include some or all of the above-described trigger conditions that trigger the recovering process; optionally, event based trigger termination and/or count timing based trigger termination may be implemented. Specific description in the above-described updating part may be referred to for details of event based trigger and/or count timing based trigger.
Optionally, the operations in the above triggering part, training part, testing part, operating and reasoning part, updating part, recovering part and terminating part, etc. can be exchanged, combined and/or replaced with each other;
Optionally, the device A and/or the device B may be network-side devices, user equipment, or devices that support bypass communication.

As an exemplary embodiment of the disclosure, the method for performing a positioning operation may simply include a training part and an operating part.

As yet another exemplary embodiment of the disclosure, a method for performing a positioning operation may basically include a training part, a testing part and an operating part.

As yet another exemplary embodiment of the disclosure, a method for performing a positioning operation may include a training part, a testing part, a training part, a testing part, a training part, a testing part, an operating part and a terminating part.

As yet another exemplary embodiment of the disclosure, a method for performing a positioning operation may include a training part, a testing part, an operating part, an updating part, an operating part, an updating part and a terminating part.

As yet another exemplary embodiment of the disclosure, a method for performing a positioning operation may include a training part, a testing part, an operating part, an updating part, an operating part, an updating part, a testing part and a terminating part.

As yet another exemplary embodiment of the disclosure, a method for performing a positioning operation may include a training part, a testing part, an operating part, an updating part, a testing part (failure), an updating part, a testing part (failure), an updating part, a testing part (failure) and a terminating part.

As yet another exemplary embodiment of the disclosure, a method for performing a positioning operation may include a training part, a testing part, an operating part, an updating part, a testing part (failure), an updating part, a testing part (failure), an updating part, a testing part (failure), a recovering part, a testing part, an operating part, an updating part, a testing part and a terminating part.

The above-mentioned exemplary embodiments are only exemplary, and those of ordinary skill in the art can make various adaptive changes within the protection scope of the disclosure.

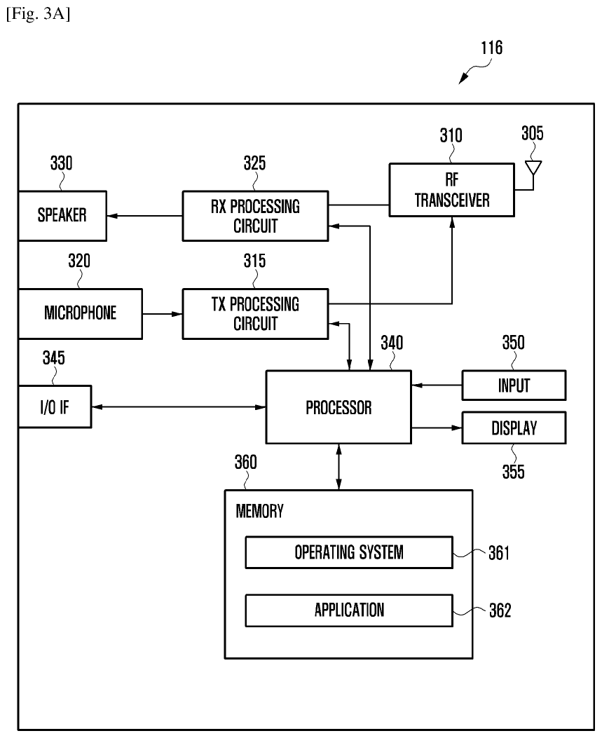

FIG. 4 shows an exemplary flow diagram of a method for performing a positioning operation according to exemplary embodiments of the disclosure.

Referring to FIG. 4, the method for performing positioning in the communication system according to the disclosure is to acquire configuration information related to a positioning-related first-type method in step 410. Then, in step 420, an operation related to positioning is performed based on the configuration information related to the positioning-related first-type method.

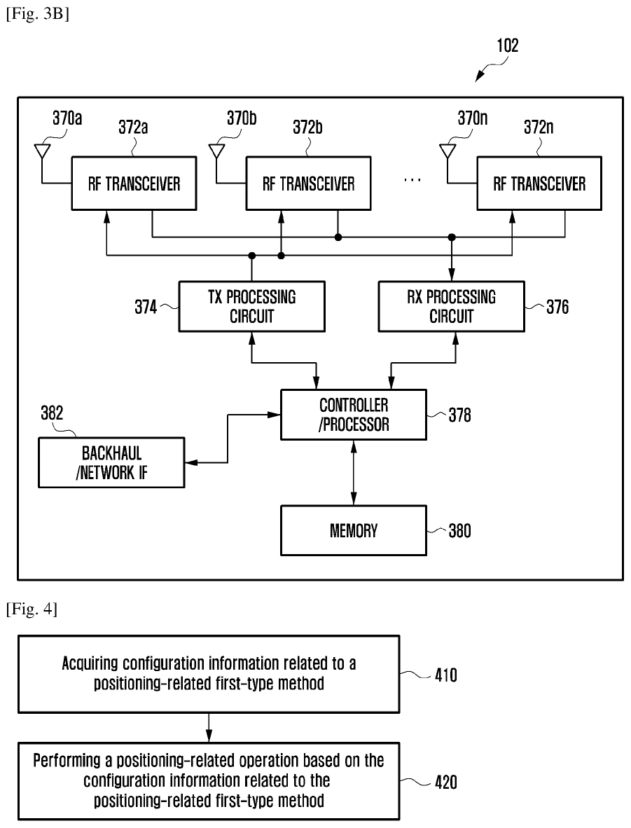

FIG. 5 shows an exemplary flowchart of a method for performing a positioning operation according to yet another exemplary embodiment of the disclosure.

More specifically, referring to FIG. 5, in step 510, it is determined whether the first-type method is triggered based on the triggering condition. If the step 510 is YES, then in step 512, a triggering process is performed based on the triggering condition to determine use of the first-type method. Then proceed to step 520. If the step 510 is NO, then in step 514, it is determined to use a conventional method.

In step 520, the first-type method is trained by using the resources for training according to the determined third node, to determine the first-type method after the training is completed and/or the configuration information related to the first-type method after the training is completed. Then proceed to step 530.

In step 530, it is determined whether the first-type method after the training is completed is valid. If the step 530 is YES, then in step 532, the UE obtains output information according to the obtained input information, the determined first-type method to be used and/or configuration information related to the first-type method. Then proceed to step 540. If step 530 is NO, then jump to step 510.

In step 540, the used first-type method and/or the configuration information related to the used first-type method is adjusted and updated. Then proceed to step 550.

In step 550, when the used first-type method does not meet the performance requirements or cannot work normally, the used first-type method and/or the configuration information related to the used first-type method need to be recovered. Then proceed to step 560.

In step 560, when the used first-type method has been used for a certain period of time and/or does not meet the requirements and/or cannot work normally, the used first-type method and/or the configuration information related to the used first-type method may be terminated. Then the whole process comes to an end.

It should be noted that the first-type method in the above process may be executed on the user equipment side, or may be executed on the network side. A person of ordinary skill in the art can omit one or more of the above steps, or exchange, combine and/or replace one or more of the above steps as required.

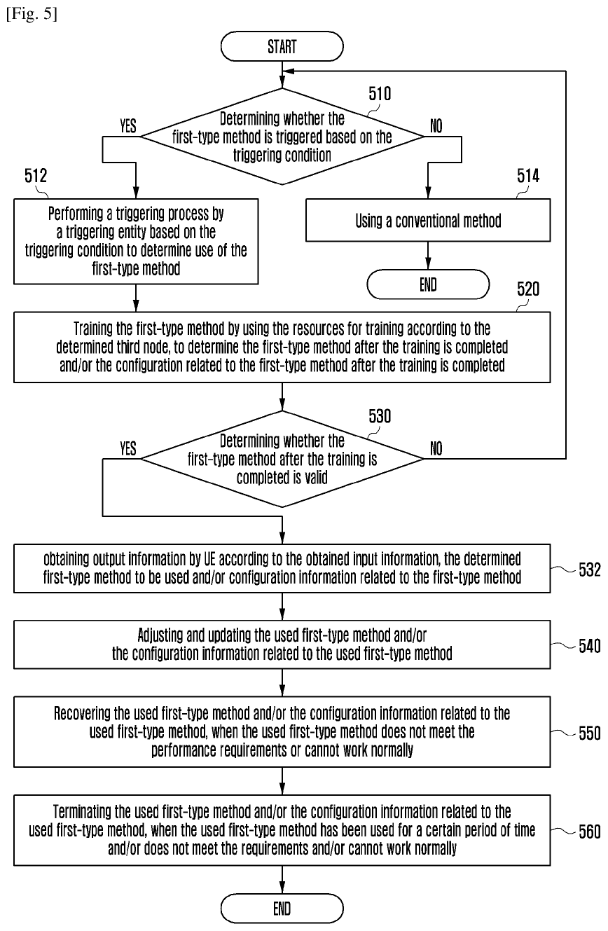

FIG. 6 shows a block diagram of an electronic device (user equipment) 600 according to an exemplary embodiment of the disclosure. The user equipment includes a transceiver 601 and a controller 602. The transceiver 601 is configured to transmit and receive signals. The controller 602 is coupled to the transceiver 601 and configured to perform at least one method related to the embodiments described in FIGS. 4 and 5 of the disclosure.

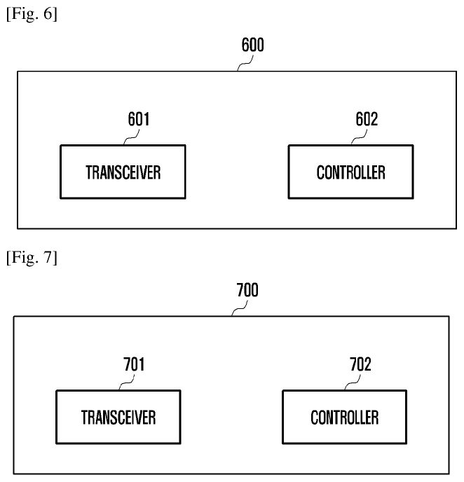

FIG. 7 shows a block diagram of a base station 700 according to an exemplary embodiment of the disclosure. The base station includes a transceiver 701 and a controller 702. The transceiver 701 is configured to transmit and receive signals. The controller 702 is coupled to the transceiver 701 and configured to perform at least one method related to the embodiments described in FIGS. 4 and 5 of the disclosure.

The disclosure further provides a computer-readable medium having computer-executable instructions stored thereon, and when the instructions are executed, it causes a processor to perform any method described in the embodiments of the disclosure.

“User Equipment” or “UE” herein may refer to any terminal with wireless communication capabilities, including but not limited to a mobile phone, a cellular phone, a smart phone or a personal digital assistants (PDA), a portable computer, an image capturing devices such as a digital camera, a gaming device, a music storage and a playback device, and any portable unit or terminal that has wireless communication capabilities, or an Internet facility that allow wireless Internet access and browsing, etc.

The term “base station” (BS) or “network device” as used herein may refer to an CNB, an eNodeB, a NodeB or a base transceiver station (BTS) or a gNB, etc., depending on the technology and terminology used.

The “memory” herein may be of any type suitable for the technical environment herein, and may be implemented using any suitable data storage technology, including but not limited to a semiconductor-based storage device, a magnetic storage device and system, an optical storage device and system, a fixed storage and a removable storage.

The processor herein may be of any type suitable for the technical environment herein, including but not limited to one or more of the following: a general-purpose computer, a special-purpose computer, a microprocessor, a digital signal processor (DSP), and a processor based on multi-core processor architecture.

The above descriptions are only preferred embodiments of the disclosure, and are not intended to limit the disclosure. Any modifications, equivalent replacements, improvements, etc. made within the spirit and principle of the disclosure shall be included in the protection scope of the disclosure.

As will be appreciated by those skilled in the art, the disclosure includes references to an apparatus for performing one or more of the operations described in this application. These devices may be specially designed and manufactured for the required purposes, or they may include those known in general purpose computers. These devices have computer programs stored therein that are selectively activated or reconfigured. Such a computer program may be stored in a device (e.g., computer) readable medium or in any type of medium suitable for storing electronic instructions and separately coupled to a bus. The computer-readable medium includes but is not limited to any type of disk (including floppy disk, hard disks optical disk, CD-ROM, and magneto-optical disk), a Read-Only Memory (ROM), a Random Access Memory (RAM), an Erasable Programmable Read-Only Memory (EPROM), an Electrically Erasable Programmable Read-Only Memory (EEPROM), a flash memory, a magnetic card or an optical card. That is, a readable medium includes any medium that stores or transmits information in a form that can be read by a device (e.g., a computer).

Those skilled in the art will understand that computer program instructions can be used to implement each block of these structural diagrams and/or block diagrams and/or flow diagrams, and combinations of blocks in these structural diagrams and/or block diagrams and/or flow diagrams. Those skilled in the art can understand that these computer program instructions can be provided to a general-purpose computer, a special-purpose computer or a processor of other programmable data processing methods to implement, so that the solutions specified in the block or blocks of the structural diagrams and/or block diagrams and/or flow diagrams disclosed in the disclosure can be executed by a computer or a processor of other programmable data processing methods.

Those skilled in the art can understand that the various operations, methods, steps, measures and solutions in the process that have been discussed in the disclosure may be alternated, modified, combined or deleted. Further, other steps, measures, and solutions in the various operations, methods, and processes that have been discussed in the disclosure may also be alternated, modified, rearranged, decomposed, combined, or deleted. Further, steps, measures and solutions in the prior art with various operations, methods, and processes disclosed in the disclosure may also be alternated, modified, rearranged, decomposed, combined or deleted.

Those skilled in the art can recognize that the disclosure can be implemented in other specific forms without changing the technical idea or essential features of the disclosure. Therefore, it should be understood that the above-described embodiments are merely exemplary and are not limitative. The scope of the disclosure is defined by the appended claims, rather than the detailed description. Therefore, it should be understood that all modifications or changes derived from the meaning and scope of the appended claims and equivalents thereof are within the scope of the disclosure.

In the above-described embodiments of the disclosure, all operations and steps may be selectively performed or may be omitted. Furthermore, the operations and steps in each embodiment need not be performed sequentially, and the order of operations and steps may vary.

While the disclosure has been shown and described with reference to various embodiments of the disclosure, those skilled in the art will appreciate that, without departing from the spirit and scope of the disclosure as defined by the appended claims and equivalents thereof, various changes may be made in form and detail.

1. A method performed by a first node in a communication system, the method comprising:
obtaining configuration information related to a positioning-related first-type method; and
performing a positioning-related operation based on the configuration information related to the positioning-related first-type method.

2. The method according to claim 1, wherein the first node is a user equipment or a network side device.

3. The method according to claim 1, wherein the positioning-related operation is triggered based on one or more of the following items:
a measured first signal is a multi-path signal;
the measured first signal is a non-line-of-sight signal;
a reference signal received power (RSRP) value of the measured first signal is greater than a threshold value;
a transmission timing error (TE) or a transmission timing error group (TEG) of the first signal is greater than a threshold value;
a reception TE or a reception TEG of the first signal is greater than a threshold value;
a transmission-reception TE or TEG of the first signal is greater than a threshold value;
the transmission-reception TE or TEG of the first signal belongs to a specific range;
an uncertain region in positioning assist information is greater than a threshold value; or
an indication of using or activating the first-type method is received.

4. The method according to claim 3, wherein in case that the at least one triggering item occurs no smaller than N times and N is a positive integer which is not smaller than 1, the positioning-related operation is triggered.

5. The method according to claim 3, wherein the indication of using or activating the first-type method is received through one or more of:
a long-term evolution (LTE) positioning protocol (LPP) message, a radio resource control (RRC) configuration message, a media access control control element (MAC CE), or downlink control information (DCI).

6. The method according to claim 3,
wherein the first node is a user equipment, and the indication of using or activating the first-type method is a feedback message of a request message of using or activating the first-type method, and
wherein the request message of using or activating the first-type method is transmitted through one or more of:
a physical uplink control channel (PUCCH), a MAC CE, a physical random access channel (PRACH), or an LPP message.

7. The method according to claim 1, wherein the configuration information related to the positioning-related first-type method includes one or more of the followings:
input information related to the first-type method and/or output information corresponding to the input information;
a type of the first-type method;
hyper-parameter configuration information;
a data set related parameter;
a weight parameter;
an offset parameter configuration;
configuration information related to a positioning reference signal;
a measurement gap of measurement; or
a related configuration of a positioning reference signal processing window.

8. The method according to claim 7, wherein at least one of the weight parameter or the offset parameter configuration includes at least one of an initial value or an update value.

9. The method according to claim 1, wherein the positioning-related operation includes at least one of training, testing, operating, updating, recovering or terminating, and
wherein the training includes one or more of the following operations:
determination of a third node; or
carrying out training of the first-type method according to the determined third node.

10. The method according to claim 9, wherein a device that satisfies one or more of the following conditions is determined as the third node:
the device has known position information;
the device reports a case of having the capability of providing the input information related to the first-type method and/or the output information;
a state capable of providing the input information and/or the output information related to the first-type method is indicated as an activated state;
the measured first signal is a single-path signal;
the measured first signal is a line-of-sight signal;
the RSRP value of the measured first signal is greater than a threshold value;
the transmission TE or the transmission TEG of the first signal is smaller than a threshold value;
the reception TE or the reception TEG of the first signal is smaller than a threshold value;
the transmission-reception TE or TEG of the first signal is smaller than a threshold value; and
the transmission-reception TE/TEG of the first signal belongs to a specific range.

11. The method according to claim 7, wherein the input information related to the first-type method is fed back through the third node.

12. The method according to claim 9, wherein the testing includes one or more of the followings:
obtaining testing data;
carrying out testing of the first-type method based on the testing data, obtaining output information, and determining validity of the first-type method; or
determining whether the testing is successfully completed based on the validity of the first-type method.

13. The method according to claim 12, wherein the validity of the first-type method is determined based on the following condition that:
a difference value between the output information and output information in the testing data is smaller than a first threshold value.

14. A first node in a communication system, the first node comprising:
a transceiver; and
a controller coupled with the transceiver and configured to:
obtain configuration information related to a positioning-related first-type method; and
perform a positioning-related operation based on the configuration information related to the positioning-related first-type method.

15. The first node of claim 14, wherein the first node is a user equipment or a network side device.
